(19) United States
(12) Patent Application Publication
(10) Pub. No.: US 2004/0053611 A1
(43) Pub. Date: Mar. 18, 2004

(54) Device and data processing system for establishing services using service profiles, pertaining program and pertaining service profile

(76) Inventor: Bernd Plagemann, Munchen (DE)

Correspondence Address: MORRISON & FOERSTER LLP, 1650 TYSONS BOULEVARD, SUITE 300, MCLEAN, VA, 22102, US

(21) Appl. No.: 10/451,223

(22) PCT Filed: Nov. 28, 2001
(86) PCT No.: PCT/DE01/04468

(30) Foreign Application Priority Data
Dec. 21, 2000 (DE) 10064148.2

(51) Int. Cl. H04Q 7/20

(52) U.S. Cl. 455/432.3; 455/435.1; 455/433

(57) ABSTRACT

The invention relates to a method which uses a global service profile (16). Said global service profile (16) contains features characteristic of telephone profiles (P1, P2) as well as features characteristic of packet network (16) allows for the fast and simple establishment of a combined access to a switched data transmission network and to a packet-switched data transmission network.

The invention relates to a method by which at least one telephone profile is stored in a data processing system, the profile containing features which can be used by subscribers in a switched data transmission network. In addition, at least one packet-switched network profile is stored containing features which can be used by subscribers in a packet-switched data transmission network.

Examples of such features in a switched data transmission network are:

ISDN features (Integrated Services Digital Network) such as for example directory number display, directory number suppression, three-way conference, hold toggle.

The use of multiple subscriber numbers.

Examples of such features in a packet-switched data transmission network are:

The use of particular bit rates.

The use of transmission services with a particular transmission quality.

A strong trend is currently evident in the telecommunications market towards convergence of the voice and data networks. This means that classical suppliers of telephone services are offering access to data transmission networks which, for example, transmit data in accordance with the Internet protocol. On the other hand, so-called Internet service providers are also increasingly penetrating into the telephone market, i.e. the Internet service providers are offering to their customers the possibility of holding telephone conversations. As a result, combined accesses will be offered by both groups of suppliers.

Telecommunication systems, for example, incorporate subscriber modules which permit high bit rate access for voice and data services (Internet) over a two-wire copper line. These techniques are known by the name of XDSL (x Digital Subscriber Line), where the lowercase x stands for an uppercase letter which more closely designates the transmission technology used. When a combined access is being established, a database must be updated for a switched transmission network. On the other hand, when a combined access is being established, it is necessary to update data in a so-called hub which forwards incoming data from the subscriber to a router. The accesses to the actual data network and to the data services are administered in the database of a so-called AAA (Authentication, Authorization, Accounting) service provision computer.

Until now, the setting up and changing of voice and data services have required the relevant subscriber data to be input on various operating devices. The rights to use the agreed features must be stored in several places. After its input into one system, data such as the unique identification of the subscriber, e.g. by means of a directory number, must be copied into one or more other systems. Coordination of these method steps is effected either manually, e.g. with the help of paper forms, or via external database systems. This has a series of disadvantages:

Technical staff must operate various terminal devices, which may have been made by various vendors. A consequence of this is high training costs.

Data input must be duplicated in various places. This implies additional cost, and can lead to discrepancies between the databases which can only be eliminated by costly synchronization measures.

There is no control over the sequence of the method steps. This can also lead to errors.

So-called service profiles, which contain a number of features, have previously already been used when setting up the access to a particular data transmission network. Any one profile combines numerous features. However, these features are all related to one data transmission network, which is distinguished from other transmission networks by its transmission technology.

It is the object of the invention to specify a simple and rapid method for setting up services with the help of service profiles, which in particular largely eliminates the load on operating staff and which is less error-prone than the methods used until now. In addition, it is to specify an associated data processing system, an associated program and an associated service profile.

The object of this method is achieved by the method steps specified in claim 1. Developments are specified in the subclaims.

The invention starts from the point of view that individual profiles have a proven value. However, individual profiles relate only to features relevant for one transmission technology. The mixing of features from different transmission technologies in one individual profile should be avoided, because otherwise it is not possible to assign the profile to a subscriber who wishes to use only one transmission technology. In order, in spite of this, to combine profiles which are relevant for different transmission technologies, a higher-level framework is required. In connection with the invention, this framework is designated as a global profile.

With the method in accordance with the invention, in addition to the method steps mentioned above, at least one global profile is stored in the data processing system, specifying at least one telephone profile and at least one packet network profile. In order to set up for a subscriber an access to the switched data transmission network and to the packet-switched data transmission network, the global profile is assigned to the subscriber. As determined by this assignment, the global profile and the profiles specified in it are read. The features specified in the profiles are set up or enabled for the subscriber.

The global profile thus contains at least two entries, which do not directly relate to features. These entries are therefore very manageable, and particularly well suited for controlling the execution of a program when setting up a combined access. This does not, however, exclude the possibility that, in addition to the profiles, one or other features may also be specified in the global profile.

No detailed technological knowledge of the various transmission technologies is required in order to assign a global profile to a subscriber. Consequently, even comparatively untrained operating staff can make an assignment rapidly and without error.

Even small improvements to the input interface have a substantial effect on the error-free and rapid performance of the method. So it is impossible to overestimate the value of improvements to the user interface.

In a development of the method according to the invention, details are stored in the global profile, either for some of the profiles specified in the global profile or for all of the profiles specified in the global profile, specifying a processing sequence in which the profiles must be processed in order to set up the combined access. This measure can be used to control a central set-up program and/or the manual input sequence. The central control program determines by reference to a profile identifier which set-up program must be used for processing the profile. By reference to the sequence specification the central set-up program determines when the program for processing a profile must be called up relative to the times when the programs for processing the other profiles must be called up. This is the prerequisite for automating the setting up of a combined access, either completely or at least partially, so as to largely relieve the workload on the operating staff. Sources of errors which can be attributed to an incorrect operating sequence are excluded by automatic execution. In addition, the method can be performed more quickly than has been possible until now.

In a further development of the method according to the invention, a telephone profile contains the specifications for an ISDN connection and/or specifications of ISDN features. Another telephone profile contains specifications for an XDSL connection. A packet network profile contains specifications for an Internet service provider. A further packet network profile stores the access rights and/or features for the use of a packet network.

In another development of the method according to the invention, at least one method for configuring a switching center in the switched network and one method for configuring a unit for forwarding data packages is automatically specified, these being dependent on the profiles contained in the global profile and preferably dependent on the sequence specification details. These measures suffice essentially to automate or semi-automate the most important steps for setting up a combined access.

With one development of the method according to the invention, in addition to executing the configuration programs identified, a method is performed to access a data processing system used to administer the access rights and/or features for a packet network, this procedure depending on a profile stored in the global profile. This measure essentially automates or semi-automates the method for setting up a combined network access. There remain only a few manual inputs and/or manual acknowledgements.

In a development, at least one parameter determined during the execution of a configuration method is used in the execution of a subsequent configuration method. Thus a parameter specifying a port number is determined when configuring the switching center and then used when setting up the Internet access. The automatic transfer of parameters excludes further sources of error. In particular, errors attributable to operating staff can no longer arise in the communication or transfer of parameters.

In another development, at least one feature contained in a telephone profile or a packet-switched network profile is confirmed by an operator or is refined by the specification of additional details. This measure enables experienced operating staff to activate features for a subscriber according to the agreed features, which differ from those for another subscriber with the same profile even though the same profile has been assigned. If a feature is not confirmed or specified more precisely by the operator, then this feature will not be set up or enabled.

In another development of the method according to the invention, the global profile contains at least one feature. This measure makes it possible to take into account in a simple way features which only arise in the case of combined accesses. If such a feature were included in an individual profile, the consequence would be that this individual profile would no longer be usable for subscribers who only wish to use one transmission technology. The creation of an additional profile containing just a single feature is then avoided.

The invention also relates to a data processing system and a program, which are used when the method in accordance with the invention or one of its developments is carried out. The technical effects detailed above also apply to this data processing system and the program.

Furthermore, the invention relates to a global service profile which contains data specifying at least one telephone profile and at least one packet network profile. This global service profile is used with the method in accordance with the invention or with one of its developments. The technical effects detailed above also transfer across to this global service profile.

In what follows, exemplary embodiments of the invention are explained by reference to the attached drawings. These show:

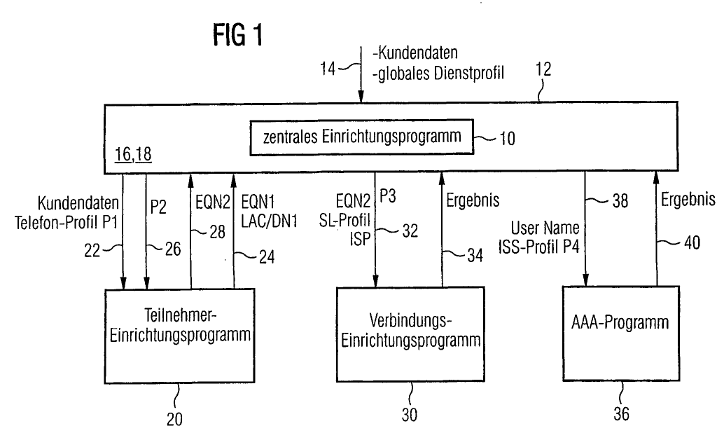

FIG. 1 a schematic representation of the data passed across to a central set-up program,

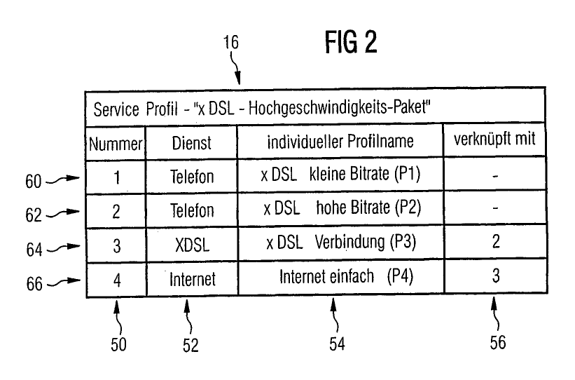

FIG. 2 a global service profile,

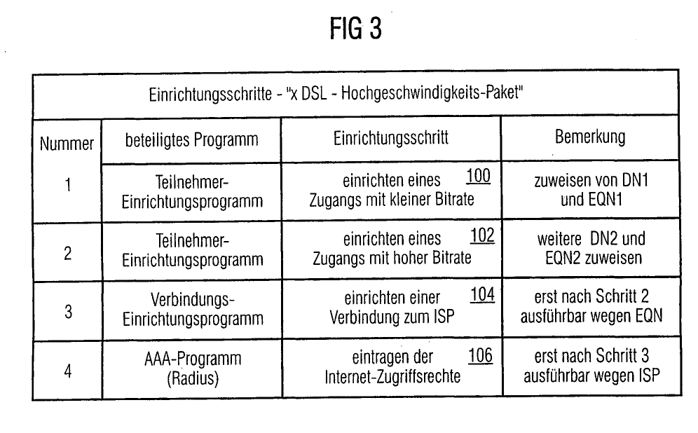

FIG. 3 the method steps in processing the global service profile, and

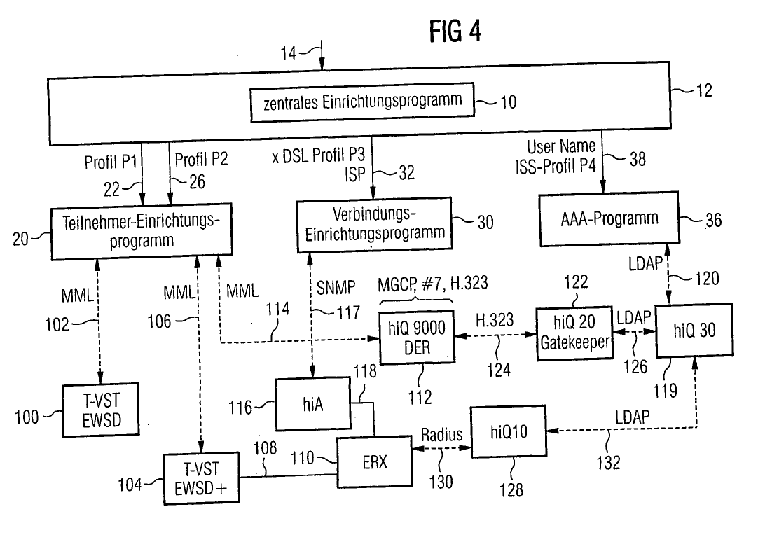

FIG. 4 the setting up of a combined network access with the help of the set-up program and the involvement of SURPASS components.

FIG. 1 shows a schematic representation of the data passed across to a central set-up program 10. This central set-up program 10 is executed on a data processing system 12. An operator, not shown, inputs customer data and the identifier of a global profile via a keyboard connected to the data processing system 12, see arrow 14. A storage unit of the data processing system 12 holds the profile 16 which is associated with the identifier together with other global profiles (not shown) which differ from the global profile 16. Also stored in the data processing system 12 are numerous individual profiles 18. The structure of the global service profile 16 is explained below in more detail by reference to FIG. 2. Each of the individual profiles 18 contains several features which all relate to the same transmission technology. However, there are individual profiles 18 for at least two different transmission technologies.

When processing the customer data and the global service profile 16, the central set-up program 10 passes to a subscriber set-up program 20 the customer data and the identifier, as noted in the global service profile 16, of an individual profile P1, see arrow 22. The subscriber set-up program 20 configures a conventional switching center, e.g. a switching center of the EWSD type (digital electronic switching system) from SIEMENS AG. In doing this, the subscriber set-up program 20 determines an unallocated directory number LAC/DN1 which consists of a local area code LAC, and a directory number DN1 which is assigned to the subscriber. In addition, the subscriber set-up program 20 determines a port number EQN1 (Equipment Number) which identifies a port on a connection module in the switching center. A subscriber line, to the subscriber who is to be set up, is connected or has been connected to the designated port. The directory number LAC/DN1 and the port number EQN1 are automatically passed across from the subscriber set-up program 20 to the central set-up program 10, see arrow 24.

The central set-up program 10 then processes the second profile, P2, noted in the global profile 16. In the case of the global profile 16, explained in more detail below by reference to FIG. 2, this is also a profile which must be processed by the subscriber set-up program 20. The central set-up program 10 therefore starts the subscriber set-up program 20 once again, and this time in doing so it passes across the customer data and an identifier for the next profile to be processed, P2, see arrow 26. The profile P2 relates to a high bit rate XDSL connection. This connection is also set up by configuring the switching center. When this is done, a still unallocated directory number LAC/DN2 and a further port number EQN2 are determined. The details determined are passed across from the subscriber set-up program 20 to the central set-up program 10, see arrow 28.

Then, either automatically or by the activation of a button, a connection set-up program 30 is called up with the help of the central set-up program 10, because the next entry in the global profile 16 specifies a profile P3 which must be processed by the connection set-up program 30. If the operator activates the button, then the central set-up program 10 passes across to the connection set-up program 30 the port number EQN2, the identifier for profile P3, and the identifier of an Internet service provider, via which access to the Internet is to be set up, see arrow 32. The connection set-up program 30 then activates a so-called hub, which undertakes the function of a concentrator for incoming data packets, and forwards the data packets to a router. If the transmission medium used between the concentrator and the router is an ATM network, then the connection set-up program 30 will, for example, define a path and channel number to be used for forwarding the data. The hub will be, for example, a component called hiA from the SURPASS system manufactured by SIEMENS AG, see the Web site with the address www.siemens.com/data&voice. The router to be incorporated is determined by reference to the identifier for the Internet service provider ISP.

The connection set-up program 30 automatically sends back a confirmation message to the central set-up program 10, in which the setting up of the Internet connection is confirmed, see arrow 34.

After the profile P3 has been processed, the profile P4 can then be processed. An operator starts the processing by activating a button which is now enabled, in the input mask. Alternatively, the processing is continued automatically. The central set-up program 10 calls up an AAA program 36 (Authentication, Authorization, Accounting), and passes across to the AAA program 36 the identifier of the profile P4 together with a character string designating the user name, see arrow 38. If applicable, the directory number of the subscriber is also passed across. The program 36 processes the data which has been passed across, and enters it into a database system which is used when a data transmission network is being accessed. For example, a so-called gatekeeper may be involved if the subscriber is using a terminal device which works in accordance with the Standard H.323 from the ITU-T (International Telecommunication Union—Telecommunication Standardization Sector). If the subscriber is using an Internet access, then the program 36 will involve a server which works in accordance with the RADIUS protocol (Remote Authentication Dial-In User Service). The program 36 then passes a confirmation parameter over to the central set-up program 10, see arrow 40. When the confirmation parameter has been received, the setting-up of the combined access is complete. A person operating the set-up program 10 will now start with the set-up of the next combined access.

FIG. 2 shows a global profile 16 which relates to an XDSL high speed connection. The service profile 16 contains four entries, which are numbered in a column 50 on the left-hand side with the digits 1 to 4. In a column 52 to the right of this, each entry specifies the name of the service affected by the entry. In a column 54 are specified the names of the profiles P1 to P4. The right-hand column 56 contains details of the sequence for the setting-up of profiles P1 to P4. One line 60 in the service profile 16 relates to the profile P1 with the name “XDSL low bit rate”. The profile P1 relates to the components for transmitting voice data on an XDSL connection. The service is specified as “Telephone”, because only voice services are being offered to the subscriber. These voice services are supplied using a two-wire copper line, i.e. a conventional telephone line, for the transmission of data between the subscriber and a switching center. The profile P1 is linked to none of the other profiles P2 to P4. This means that the profile P1 can be set up without the need for another profile P2 to P4 to be set up first.

The next line 62 in the service profile 16 contains details of the profile P2 with the name “XDSL high bit rate”. The profile P2 is thus the part for data communication in the case of an XDSL connection. However, as the access again uses the two-wire copper line, i.e. a conventional telephone line, the service is specified as “Telephone”. As will be seen from column 56, the profile P2 is not linked to any other profile P1, P3 or P4. Consequently there are no conditions for the time point at which the profile P2 is set up.

In the following line 64 of the profile 16, a name “xDSL connection” is specified for the profile P3. When the profile P3 is processed, an Internet access will be set up. The name given for the service is “xDSL”. As can be seen from column 56, the profile P3 is linked to the profile P2. This means that the profile P3 cannot be set up until after the profile P2 has been set up.

Line 66 of the global service profile 16 contains details of the profile P4. The profile P4 bears the name “Internet only” and is assigned to the service “Internet”. As can be seen from column 56, the profile P4 is linked to Profile P3. This means that the profile P4 can only be set up if the profile P3 has been set up.

FIG. 3 shows the method steps in processing the global service profile 16, see FIG. 2. The method begins with a method step 100 which sets up the access at the low bit rate. In doing this the subscriber set-up program 20 is involved, as explained above by reference to FIG. 1. The result is that the subscriber is assigned a directory number DN1 and a port number EQN1.

After method step 100 comes a method step 102, in which the profile P2 is processed. This sets up an access with a high bit rate. As already explained above by reference to FIG. 1, the subscriber set-up program 20 is called up once again. The result is that a directory number DN2 and a port number EQN2 are determined.

There then follows a method step 104. Before method step 104 is executed a check is made, because of the link to the profile P2, as to whether step 102 has already been executed. If so, then the connection set-up program 30 is started, as already explained above by reference to FIG. 1, to set up an Internet access. If method step 102 has not yet been successfully executed, then the execution of method step 104 is delayed, for example by disabling a button used to call method step 104.

In the processing of the global service profile 16 by the central set-up program 10, the method step 106 to enter the Internet access rights using the program 36, as explained above by reference to FIG. 1, will not be performed until the profile P3 has been successfully processed. An example of how this could be achieved is that a button, used by an operator to request the calling up of method step 106, is only enabled after the successful performance of method step 104.

FIG. 4 shows the setting up of a combined network access with the help of the set-up program 10 and the involvement of SURPASS components, as explained below. In the processing of the profile P1, the subscriber set-up program 20 configures a subscriber switching center 100, e.g. of type EWSD from SIEMENS AG or of type S12 from ALCATEL. To activate the switching center 100, use is made of a proprietary protocol, MML (Man Machine Language), see arrow 102. The subscriber switching center 100 also uses the MML protocol, to send messages to the subscriber set-up program 20.

In processing the profile P2, the subscriber set-up program 20 involves a component 104, which is a component of the subscriber switching center 100 or another subscriber switching center, to which is connected the subscriber whose details are to be set up. The component 104 could be, for example, a component of a further development of an EWSD-type switching center. To activate the component 104, the MML protocol is again used, see arrow 106. A transmission path 108 can be established from the component 104 to a router 110 which belongs to an Internet service provider, and using which data can be forwarded between different local networks in accordance with prescribed routing methods. For example, on the transmission path 108 data packets are transmitted in accordance with the ATM protocol.

In processing the profile P1 or the profile P2, as applicable, the subscriber set-up program 20 also activates a service provision computer 112, which controls the linkage of a telephone network and a data network. The service provision computer 112 corresponds, for example, to the hiQ or hiQ 9000 component of the SURPASS system. The service provision computer 112 activates elements required to provide the features, such as network gateways using the MGCP protocol (Media Gateway Control Protocol), other switching centers using the ISUP protocol (ISDN User Part), or units which work in accordance with the Standard H.323 from the ITU-T. The subscriber set-up program 20 and the service provision computer 112 exchange control messages in accordance with the MML protocol, see arrow 114.

In the processing of the profile P3, the connection set-up program 30 activates a so-called hub 116 using the SNMP protocol (Simple Network Management Protocol), see arrow 117. The hub 116 might correspond, for example, to the hiA component of the SURPASS system. Data packets incoming from a subscriber to the hub 116 are forwarded over a transmission path 118 to the router 110.

In processing the profile P4, the AAA program 36 uses the LDAP protocol (Light Directory Access Protocol) to access a database server 119, in order to enter the access data and the agreed features for the subscriber, see arrow 120. The database server 119 is used by a gatekeeper unit 122. This gatekeeper unit 122 works in accordance with the ITU-T's H.323 and H.225 protocols and in accordance with H.245. The gatekeeper unit 122 could be, for example, the hiQ20 component of the SURPASS system. In providing the features, the service provision computer 112 establishes an H.323 signaling path 124 to the gatekeeper unit 122. For its part, the gatekeeper unit 122 accesses the database server 119 using the LDAP protocol, see arrow 126.

Also involved in providing the features relating to the Internet is a server 128, which controls the router 110 in accordance with the RADIUS protocol, see arrow 130. In doing this, the server 128 also accesses the database server 119 using the LDAP protocol, see arrow 132.

The function of the components of the SURPASS system shown in FIG. 4 is explained in more detail in the product descriptions for these components, see for example the web page www.siemens.com/data&voice. However, other components and transmission protocols between the components are also used in order to set up and use combined network accesses.

In another exemplary embodiment of the global profile 16, see FIG. 2, there are no data fields in the global profile 16 for specifying the number of the entry, and no data fields for entering the service. This means that the service profile 16 only contains the details shown in columns 54 and 56.

1. Method for setting up services with the assistance of service profiles (16, 18), in which
at least one telephone profile (P1, P2) is stored, containing features which can be used by subscribers in a switched data transmission network,
at least one packet network profile (P3, P4) is stored, containing features which can be used by subscribers in a packet-switched data transmission network,
at least one global profile (16) is stored in a data processing system (12), with at least one telephone profile (P1, P2) and at least one packet network profile (P3, P4) being specified in this global profile,
the global profile (16) is assigned to a subscriber in order to set up for that subscriber an access to the switched transmission network and to the packet-switched network,
the global profile (16), as determined by the assignment, is read together with the profiles specified in it (P1 to P4),
and the features specified in the profiles (P1 to P4) are set up and/or enabled for the subscriber.

2. Method in accordance with claim 1, characterized in that for at least some of the profiles (P3, P4) specified in the global profile (16) a specification (56) is stored which defines a processing sequence, in which the profiles (P1 to P4) must be processed.

3. Method in accordance with claim 1 or 2, characterized in that the details for an ISDN connection and/or the details for ISDN features are contained in a telephone profile (P1),
and/or that the details for an XDSL connection are contained in a telephone profile (P2),
and/or that the details for an Internet service provider are contained in a packet network profile (P3),
and/or that access rights and/or features for the use of a packet network are stored in a packet network profile (P4).

4. Method in accordance with one of the preceding claims, characterized in that depending on the profiles (P1 to P4) which are contained in the global profile (16) and preferably depending on the sequence specification details (56), at least a method (20) for configuring a switching center (100) in the switched network, and a method (30) for configuring a unit (116) for forwarding data packets are automatically or manually carried out.

5. Method in accordance with claim 4, characterized in that depending on a profile (P4) which is stored in the global profile (16) and preferably depending on the sequence specification details (56), a method (36) for accessing a data processing system (18) which administers the access rights and/or features for a packet network is carried out.

6. Method in accordance with claim 4 or 5, characterized in that at least one parameter, determined when a configuration procedure (20) is carried out, is used when a subsequent configuration procedure (30) is carried out, the parameter being preferably a parameter (EQN2) which specifies the port number of an interface via which a subscriber is connected by a connection unit to the switching center (104).

7. Method in accordance with one of the preceding claims, characterized in that the switched data transmission network transmits voice data in time slots in accordance with a time division multiplexing method,
and/or that data packets are communicated in the packet-switched data network subject to the analysis of the routing data contained in each of them, the packet-switched data network preferably working in accordance with the Internet protocol or in accordance with the ATM protocol or in accordance with a development of one of these protocols.

8. Method in accordance with one of the preceding claims, characterized in that at least one feature contained in a telephone profile (P1, P2) or in a packet network profile (P3, P4) is confirmed by an operator or is defined more precisely by at least one specification input by the operator.

9. Method in accordance with one of the preceding claims, characterized in that at least one feature is specified directly in the global profile (16).

10. Data processing system (12) characterized in that the data processing system (12) is so configured that in its operation it carries out a method in accordance with one of the preceding claims.

11. Program (10) with a sequence of instructions which, when executed by a processor, carries out the method steps relating to the global profile (16) in accordance with one of the claims 1 to 9.

12. Global service profile (16) characterized in that it contains data which specifies at least one telephone profile (P1, P2) and at least one packet network profile (P3, P4), in which
the telephone profile (P1, P2) is stored in a data processing system (12) and contains features which can be used by subscribers in a switched data transmission network,
and the packet network profile (P3, P4) is stored in a data processing system (12) and contains features which can be used by subscribers in a packet-switched data transmission network.

13. Service profile (16) in accordance with claim 12, characterized in that it contains specifications (56) which are required in carrying out a method in accordance with one of claims 1 to 9.
